(19) United States
(12) Patent Application Publication
(10) Pub. No.: US 2025/0280753 A1
(43) Pub. Date: Sep. 11, 2025

(54) ERGONOMIC DIBBLE GARDENING TOOL

(71) Applicant: Oregon State University

(72) Inventors: Michelle Markesteyn, Hubbard, OR (US); Seth R. O'Brien, Corvallis, OR (US); Ethan N. Pohlschneider, Corvallis, OR (US)

(73) Assignee: Oregon State University, Corvallis, OR (US)

(21) Appl. No.: 18/600,546

(22) Filed: Mar. 8, 2024

(51) Int. Cl. A01C 5/02

(52) U.S. Cl. CPC A01C 5/02

(57) ABSTRACT

A garden dibble, comprising: a shank, wherein the shank is rectilinear and has a rectangular footprint and a rectangular cross-section, wherein the shank has a length, a width and a thickness, wherein the thickness is between a first face of the shank and a second face of the shank opposite the first face, wherein the length is at least 6 times the thickness and the width is at least twice the thickness; a plurality of rule marks on the first face of the shank, wherein the plurality of rule marks is distributed along the length of the shank; at least two holes extending through the thickness of the shank between the first face and the second face, wherein the at least two holes are distributed along the length of the shank; and a tooth that extends from an end of the shank, wherein the tooth is substantially triangular.

### BACKGROUND

Most garden tools designed for youth are miniature versions of less effective adult tools. They do not necessarily consider how youth leverage their bodies to work in a garden. The way that adults and children interact with the earth and the ergonomics needed for tools are very different. In the interest of safety, the utility of garden tools for youth is limited, often rendering them ineffective. For example, youth shovels may have such rounded edges they do not easily break up the soil.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical implementations can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1A illustrates a plan view of a binder dibble in accordance with at least one implementation.

FIG. 1B illustrates a profile view of the front edge of the binder dibble shown in FIG. 1A in accordance with at least one implementation.

FIG. 2A illustrates an enlarged plan view of a first tooth example of a binder dibble, in accordance with at least one implementation.

FIG. 2B illustrates an enlarged plan view of a second tooth example of a binder dibble, in accordance with at least one implementation.

FIG. 2C illustrates an enlarged plan view of a third tooth example of a binder dibble, in accordance with at least one implementation.

FIG. 3 illustrates a plan view of a binder dibble stowed in a three-ring binder, in accordance with at least one implementation.

FIG. 4 illustrates a view of a binder dibble in use to prepare a furrow for planting, in accordance with at least one implementation.

FIG. 5 illustrates a view of a binder dibble in use to finish planting, in accordance with at least one implementation.

FIG. 6 illustrates a flowchart summarizing a method for using a binder dibble, in accordance with at least one implementation.

### DETAILED DESCRIPTION

Few, if any, garden tools designed for youth are created for the specific needs of school gardens. Tools for youth in school gardens are to be cleaned and sanitized. They also are to be easily stored as classroom space is limited. It is desirable for tools for school gardens to be brightly colored, so they may not get lost outdoors, and made from durable materials. Some dibbles may have sharp, pointed edges that may pose a safety hazard for children and adult users. Dibbles may be cylindrical in design, which may not allow for easy storage of multiple dibbles or personal transport. Some dibbles are made of wood and therefore may not be easily sanitized as needed for the classroom setting. Some dibbles may not have a combination of multiple directional measurements, increasing the orientations that the dibble needs to maneuver to successfully plant seeds. Dibbles may have inch measurements demarcated up to six inches. Most seeds in school gardens are planted less than one inch deep. Lower elementary-aged students may not have been instructed in fractions and/or developed the cognitive capacity to infer fractional depth measurements from one-inch dibble markings and may require fractional markings for guidance.

Disclosed herein is a dibble gardening implement that is ergonomically designed for specific use by elementary and middle school-aged children. In at least one implementation, the dibble is adapted for use by school-aged children in gardens that are commonly organized and managed by elementary schools. Research has shown that most school-aged children instinctively hold and use tools differently from adults, thus, in at least one implementation, the dibble is scaled and shaped to ergonomically fit in and be held by hands of school-age children. Compared to similar garden implements made for adults, the dibble of at least one implementation is significantly more efficient as a single tool for making holes in soil, digging shallow furrows to a desired depth, and for covering newly planted seeds within those holes or furrows by school-aged children.

In at least one implementation, the dibble (also referred to as a “binder dibble”) has a substantially two-dimensional body plan, comprising a flattened rectangular shank for grasping that has a similar shape to a measurement ruler. Contrary to conventional dibbles having a coaxial sharped point at the end of a cylindrical shaft, in at least one implementation, the dibble comprises a triangular tooth that extends orthogonally from an edge of the shank, whereby the apex of the tooth is distal to the shank edge. In at least one implementation, the tooth may be shaped as an equilateral triangle, isosceles triangle (two equal sides), a scalene triangle (no equal sides), as a right triangle.

In at least one implementation, the point of the tooth is oriented such that the point is substantially vertical to the ground when the disclosed dibble is held by a child, whereby the shank is in line with the child's hand or wrist. When a child strikes the ground to make a smash-point, the child has a tendency to hold the shank in a manner that is natural to the child, so that the child does not have to hold the disclosed dibble at an angle that is mechanically awkward for the child. In this manner, the child may apply a maximal striking force to break the soil when striking garden soil (e.g., normally prepared garden soil) with the tooth of the disclosed dibble, enabling maximal efficiency of motion of the child's hand and arm.

In at least one implementation, the tooth is disposed at one end of the shank to provide highest ergonomic deployment of the disclosed dibble to enable highest striking and dragging (e.g., to dig a furrow by dragging the tooth through the soil) efficiency. For furrow formation, children tend to drag a tool towards them. In at least one implementation, the tooth is located substantially at an end of the shank of the disclosed dibble to maximize hand and arm motion, as the child may grasp the shank in line with the wrist. Such a grasp can be naturally intuitive and therefore ergonomic for a child. For example, a child may tend to pull the disclosed dibble toward or across themself when dragging the tooth through the soil to dig a furrow. In at least one implementation, the apex of the tooth is rounded for safety, whereby the apex has a radius of curvature that is greater than 0.1 inch (e.g., approximately 2.5 mm) but not greater than 1 inch (e.g., approximately 25 mm) to permit a sufficient striking force to break through the surface of normally prepared garden soil.

In at least one implementation, the tooth comprises a plurality of depth marks to denote penetration depth of the tooth into soil. In at least one implementation, depth marks extend laterally (e.g., parallel to long edges of the shank) partially across a wide surface of the tooth. For example, the plurality of depth marks may have a maximum extent of several millimeters, whereby the tooth may have a width of, for instance, 0.5 inch to 3 inches (e.g., 12 to 75 millimeters) at its base. In at least one implementation, the depth marks are raised (e.g., embossed) to a height of, for instance, 0.01 inch to 0.03 inch (e.g., 25 to 75 microns) above the wide surface of the tooth for visibility. In at least one implementation, partial lateral extension of the depth marks enables more efficient cleaning of the disclosed dibble, as full lateral extension across the width of the tooth may enable soil to accumulate on the tooth, necessitating more frequent and arduous cleaning. In at least one implementation, partial extension of the depth marks reduces the tendency of soil to adhere to the tooth, reducing the frequency yet increasing the ease of cleaning of the disclosed dibble.

In at least one implementation, the depth marks are spaced vertically (e.g., from point to base) by a constant distance. For example, four depth marks are arrayed in a stack and may be spaced apart vertically by 0.25 inch (e.g., approximately 6 mm), whereby a lowest depth mark may be offset from (e.g., above) the tip by 0.25 inch, and the three remaining depth marks may appear at incremental distances (offsets) of 0.25 inch above each other, where the fourth depth mark is in line with a lower edge of the shank (e.g., to which the widest portion of the tooth is attached).

Many conventional dibbles sold in the United States have depth markings spaced apart by one-inch intervals, requiring an ability to estimate fractional distances. In at least one implementation, depth marks are unlabeled with numerical indicators as many young children may not have had educational instruction in fractional distance until third or fourth grade. For example, for many plantings, seeds are commonly planted at depths of one inch (25 mm) or less. In at least one implementation, the tooth may have a height of one inch from base to tip. Instructing a child to make a hole that is one-half or three-quarters of an inch deep may not have meaning to the child, as they may not yet understand numerators and denominators even if they generally understand the concept of fractions. However, instructing a child to make a hole two marks or three marks deep, or four marks deep (e.g., burying the entire tooth) by striking the tooth into the soil to such a depth may be more easily understood and followed by the child, as the child may be able to count the marks and therefore aids in furthering conceptual understanding of fractional distance.

In at least one implementation, the shaft of the disclosed dibble is ruled with a plurality of ruler marks spaced apart by one-inch incremental distances. In at least one implementation, such marks may guide lateral placement of seeds. For example, if a child is instructed to plant seeds a distance of approximately 3 inches from each other within a row, and to separate rows by 12 inches apart, a child may be able to readily measure such a distance by using the shank as a ruler. In at least one implementation, numerical labels are included adjacent to the ruler marks to facilitate measurements using the ruled shank. In at least one implementation, the shank of the disclosed dibble has rounded corners for safety. In at least one implementation, the shank may have a length ranging from 3 inches to 14 inches and width ranging from 0.5 inch to 4 inches.

In at least one implementation, the shaft of the disclosed dibble includes two or more binder holes distributed along a long edge of the shank. For example, two or more binder holes may be adjacent to and distributed along a second (e.g., upper) long edge of the shank, parallel to the first (e.g., lower) long edge from which the tooth extends. In at least one implementation, the two or more binder holds may be dimensioned to enable the disclosed dibble to be secured within a binder notebook by clamping rings for ease of storage. For example, the disclosed dibble may include three binder holes dimensioned to align to the three clamping rings of a standard three-ring binder notebook sold in the United States (binder holes may be distanced to accommodate other ring notebook standards as well). In at least one implementation, a center-located binder hole may be oval-shaped, while end binder holes may be circular. In at least one implementation, the two or more binder holes enable the disclosed dibble to be conveniently stowed and carried within a notebook or clipboard by a school child from classroom to garden at a school, for example. Similar remarks apply to home gardens as well.

In at least one implementation, the disclosed dibble may be dimensioned to have a thickness suitable (e.g., between 0.1 inch to 0.5 inch) for portable storage of multiple dibbles within a notebook such as a three-ring binder, or on a clipboard, for example. Stowage of multiple dibbles within a notebook or clipboard may facilitate carrying a plurality of dibbles from classroom to garden by a teacher, teaching assistant, parent, or student, for example. In at least one implementation, the indicated thickness range may be suitable for stowing and carrying the disclosed dibble in a convenient pants pocket, a shirt pocket or in a backpack compartment.

Here, some methods and devices may be shown in block diagram form, rather than in detail, to avoid obscuring present disclosure. Reference throughout this specification to “an implementation” or “one implementation” or “some implementations” means that a particular feature, structure, function, or characteristic described in connection with an implementation is included in at least one implementation of disclosure. Thus, appearances of phrase “in an implementation” or “in one implementation,” “in at least one implementation,” or “some implementations” in various places throughout this specification are not necessarily referring to same implementation of disclosure. Furthermore, particular features, structures, functions, or characteristics can be combined in any suitable manner in one or more implementations. For example, a first implementation can be combined with a second implementation anywhere particular features, structures, functions, or characteristics associated with two implementations are not mutually exclusive. A list of definitions follows, whereby following definitions may provide or augment literal support for claims.

Here, “garden dibble” may generally refer to a garden or agricultural implement for creating holes in soil for planting seeds. A conventional dibble is a wooden, plastic or metal stick with a sharp point on one end. A dibble may be used by simply poking a hole in soil to certain depth.

Here, “coupled” and “connected,” along with their derivatives, can be used to describe functional or structural relationships between components. These terms are not intended as synonyms for each other. Rather, in particular implementations, term “connected” can be used to indicate that two or more elements are in direct physical, optical, or electrical contact with each other. Here, “coupled” can be used to indicate that two or more elements are in either direct or indirect (with other intervening elements between them) physical, electrical or in magnetic contact with each other, and/or that two or more elements co-operate or interact with each other (e.g., as in a cause-and-effect relationship). Here, “coupled” can also generally refer to direct attachment of one electronic component to another. An electric or magnetic field can couple one component to another, where field may be controlled by one component to influence other in some manner.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one implementation, such variation is no more than +/−10% of referred value.

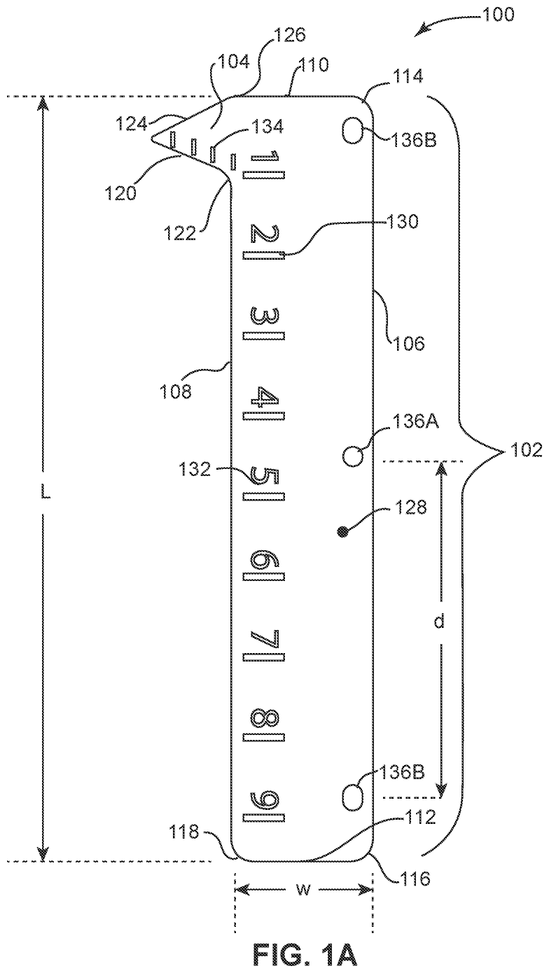

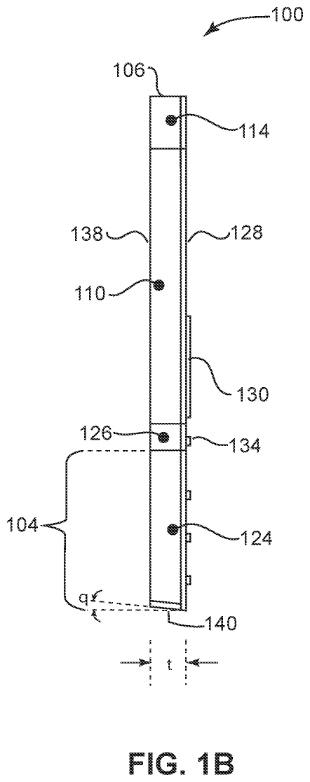

FIG. 1A illustrates a plan view of a binder dibble 100, in accordance with at least one implementation. In at least one implementation, binder dibble 100 comprises a shank 102 and a tooth 104 extending from shank 102. In at least one implementation, shank 102 is substantially rectangular, comprising an upper edge 106 and an opposing parallel lower edge 108. In at least one implementation, upper edge 106 and lower edge 108 are long edges, in contrast to orthogonally oriented opposing short edges described below. In at least one implementation, upper edge 106 and lower edge 108 are separated by width w. In at least one implementation, width w ranges between 0.5 and 4 inches (e.g., approximately between 1 cm to 10 cm). Here, “upper” and “lower” in this context refer to a working orientation of binder dibble 100, whereby upper edge 106 is generally oriented above lower edge 108 (relative to ground) when binder dibble 100 is in use. In at least one implementation, upper edge 106 may be oriented below lower edge 108, for example, when binder dibble 100 is used to scrape soil into a furrow or hole to cover newly planted seeds.

In at least one implementation, shank 102 comprises a front edge 110 adjacent to tooth 104, and an opposing rear edge 112. In at least one implementation, front edge 110 and rear edge 112 extend orthogonally from upper edge 106 and lower edge 108. In at least one implementation, shank 102 is elongated, having a length L extending between, for example, 3 and 14 inches (e.g. approximately 7.5 to 35 cm) between front edge 110 and rear edge 112. Here, “front” and “rear” in this context refer to a working orientation of binder dibble 100, whereby shank 102 is grasped behind tooth 104 so that tooth 104 may be struck against the ground to produce holes or dug into the soil and dragged toward the user. For reference purposes, tooth 104 is positioned at or near the front or head of implement (e.g., binder dibble 100) for maximal ergonomic utility. In at least one implementation, binder dibble 100 has a length-to-width aspect ratio between 6:1 and 30:1.

In at least one implementation, upper edge 106 is joined to front edge 110 by and rear edge 112 by fillet 114 and fillet 116, respectively. In at least one implementation, fillets 114 and 116 are round-shaped as approximately 90-degree circular arcs. In at least one implementation, fillets 114 and 116 have a radius of curvature ranging between 0.1 inch and 1 inch (e.g., approximately 2.5 mm to 25 mm). In at least one implementation, rear edge 112 is joined to lower edge 108 by a fillet 118. In at least one implementation, fillet 118 also follows a circular arc having a radius of curvature ranging between 0.1 inch and 1 inch. In at least one implementation, lower edge 108 is joined to a trailing edge 120 of tooth 104 by a fillet 122. In at least one implementation, fillet 122 has a circular or oval arc shape, having a radius of curvature ranging between 0.1 inch and 1 inch. In at least one implementation, leading edge 124 is joined to front edge 110 by fillet 126. In at least one implementation, fillet 126 has a radius of curvature ranging between 0.1 and 1 inch. Rounded corners enable safe handling and storage of binder dibble 100.

In at least one implementation, shank 102 comprises a front face 128, where front face 128 is substantially rectangular. In at least one implementation, a plurality of rule marks 130 are distributed on front face 128 along length L of shank 102. In at least one implementation, rule marks 130 have an extruded prismatic shape raised above front face 128. For example, rule marks 130 extend above front face 128 by a height ranging between 0.01 inch to 0.03 inch (e.g., approximately 0.25 mm to 0.75 mm). In at least one implementation, rule marks 130 have a separation of approximately 1 inch along length L of shank 102. In at least one implementation, a plurality of numerical indicators 132 are included to label individual rule marks 130 by distance in inches from front edge 110. Numerical indicators 132 may enable use of shank 102 as a ruler. In at least one implementation, rule marks 130 may be used for measuring distances between seeds during planting.

In at least one implementation, tooth 104 comprises a plurality of depth marks 134 disposed at a regular interval in a stack. In at least one implementation, depth marks 134 also have an extruded prismatic shape raised above tooth 104 by a height ranging between 0.01 inch to 0.03 inch. In at least one implementation, depth marks 134 extend laterally partially across the width of tooth 104. For example, depth marks 134 have a length of 0.25 inch, whereas tooth 104 has an expanding width ranging between 0.2 at the apex to 3 inches at the base. Partial extension of depth marks 134 may reduce accumulation of soil on tooth 104, whereas full extension across the width of tooth 104 may encourage accumulation of soil. In at least one implementation, depth marks 134 are separated from one another by, for instance, 0.25 to 0.5 inch (e.g., approximately 6 mm to 12 mm). In at least one implementation, depth marks 134 aid estimation of fractional inches to produce precise hole or furrow depths.

In at least one implementation, shank 102 comprises two or more binder holes 136. In at least one implementation, shank 102 comprises three binder holes 136. In at least one implementation, binder holes 136 are circular holes (e.g., binder hole 136A having a diameter of 0.2 inch to 0.3 inch), or short, oval-shaped slots (e.g., binder holes 136B) are separated by a distance d, symmetrical about center binder hole 136A. In at least one implementation, d is approximately, for example, 4.25 inches to enable insertion of binder dibble 100 into a ring binder (e.g., standard dimensions for a three-ring binder sold in the U.S.). In at least one implementation, binder holes 136 may be dimensioned and spaced apart by other distances to accommodate other ring binder standards.

In at least one implementation, binder dibble 100 comprises a semiflexible polymeric material, such as polystyrene, high-density polyethylene or high-density polypropylene, Acrylonitrile Butadiene Styrene (ABS), polyimide (e.g., Nylon), polyethylene terephthalate (PET), or a polycarbonate composition, such as Makrolon 2407. The polymer may be resistant to outdoor ultraviolet exposure and have sufficient mechanical strength to withstand repeated striking and digging in garden soil.

FIG. 1B illustrates a profile view of the front edge of binder dibble 100, in accordance with at least one implementation. In at least one implementation, binder dibble 100 has a thickness t between front face 128 and opposing rear face 138. In at least one implementation, thickness t ranges between 0.1 and 0.5 inch. In at least one implementation, binder dibble 100 has a width-to-thickness aspect ratio between 5:1 and 40:1. In at least one implementation, apex 140 of tooth 104 is chamfered by a chamfer angle q. In at least one implementation, the chamfer may aid penetration of tooth 104 into soil. In at least one implementation, chamfer angle q ranges between 3 degrees and 10 degrees.

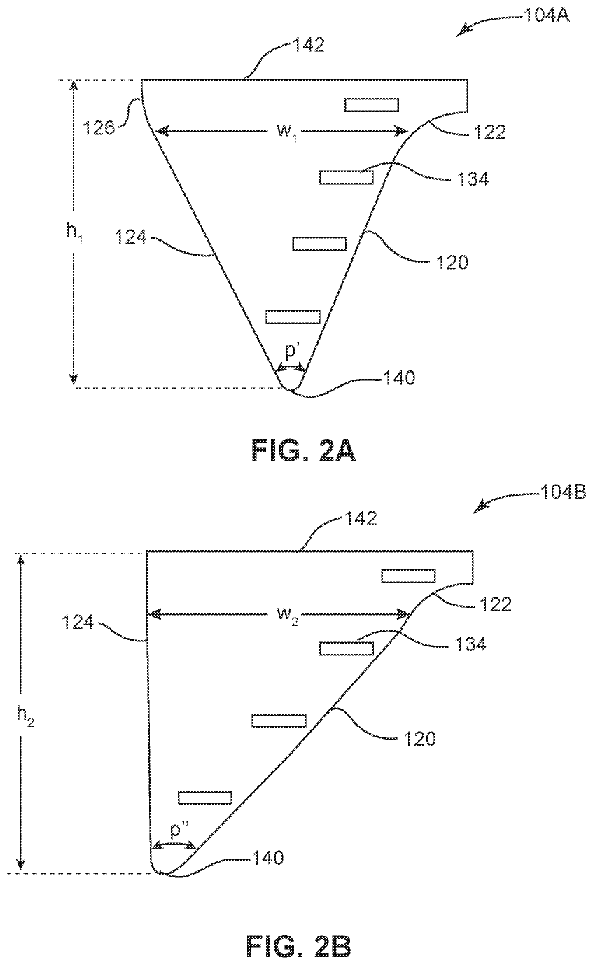

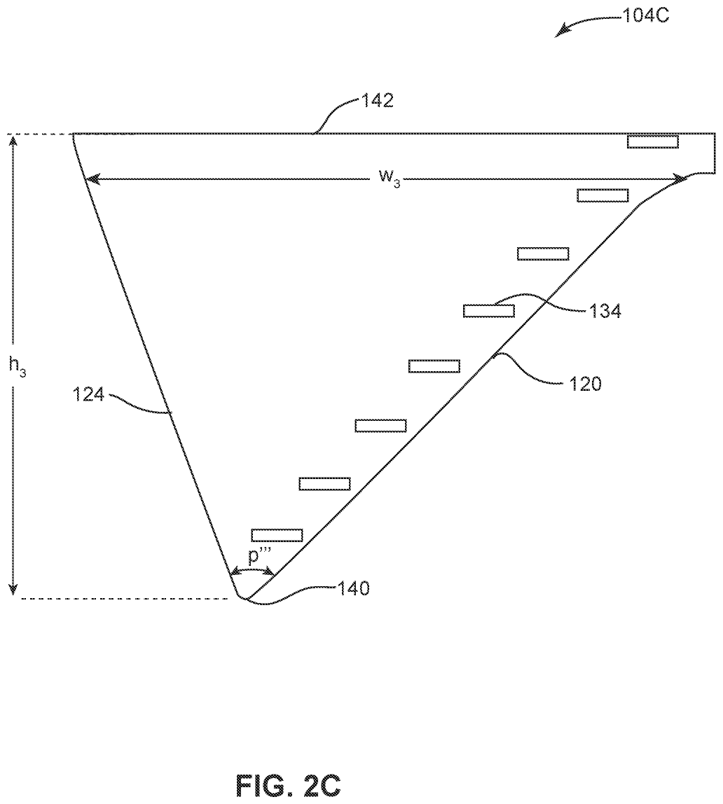

FIG. 2A illustrates an enlarged plan view of tooth 104A, in accordance with at least one implementation. Tooth 104A has been substantially described in reference to tooth 104 in FIGS. 1A and 1B. In at least one implementation, tooth 104A approximates an isosceles triangle, whereby leading edge 124 and trailing edge 120 are approximately the same length. In at least one implementation, tooth 104A extends a height h1 from apex 140 to base 142, whereby base 142 is colinear with lower edge 108 (see FIG. 1A). In at least one implementation, height h1 ranges between 0.5 inch and 2 inches. In at least one implementation, tooth 104A has a width w1 that may be measured from the top of leading edge 124 (e.g., at junction with fillet 126) and the top of trailing edge 120 (e.g., at junction with fillet 122). In at least one implementation, w1 ranges between 1 inch and 3 inches. In at least one implementation, angle p′ of apex 140 is subtended by leading edge 124 and trailing edge 120. In at least one implementation, angle p′ is an acute angle that ranges from 15 degrees to 60 degrees. In at least one implementation, angle p′ may be adjusted to blunt apex 140 for safety purposes yet have enough of a point to enable penetration of tooth 104A into prepared garden soil with relatively low force as may be imparted by an elementary or middle school-aged student wielding binder dibble 100.

FIG. 2B illustrates an enlarged plan view of tooth 104B in accordance with at least one implementation. In at least one implementation, tooth 104B approximates a right triangle. In at least one implementation, leading edge 124 extends orthogonally (e.g., at a right angle) from base 142, and trailing edge 120 extends at an oblique angle with respect to base 142. In at least one implementation, angle p″ at apex 140 is subtended by leading edge 124 and trailing edge 120. In at least one implementation, angle p″ ranges between 20 degrees and 60 degrees.

In at least one implementation, tooth 104B extends a height h2 from base 142 to apex 140. In at least one implementation, height h2 ranges from 0.5 inch to 2 inches. In at least one implementation, tooth 104B has a width w2 extending the top of leading edge 124 to the top of trailing edge 120. In at least one implementation, width w2 ranges from 1 inch to 3 inches.

FIG. 2C illustrates an enlarged plan view of tooth 104C, in accordance with at least one implementation. In at least one implementation, tooth 104C approximates a scalene triangle. In at least one implementation, leading edge 124 and trailing edge 120 have different lengths and extend at oblique angles from base 142. In at least one implementation, tooth 104C extends a height h3 from base 142 to apex 140. In at least one implementation, height h3 ranges from 0.5 inch to 2 inches. In at least one implementation, tooth 104B has a width w3 extending the top of leading edge 124 to the top of trailing edge 120. In at least one implementation, width w3 ranges from 1 inch to 3 inches. The illustrated implementation shown in FIG. 2C shows tooth 104C to have a wide base 142 whereby width w3 is 2 inches to 3 inches. This is contrasted with tooth 104A and tooth 104B, where widths w1 and w2 are approximately 1 inch in the illustrated implementations.

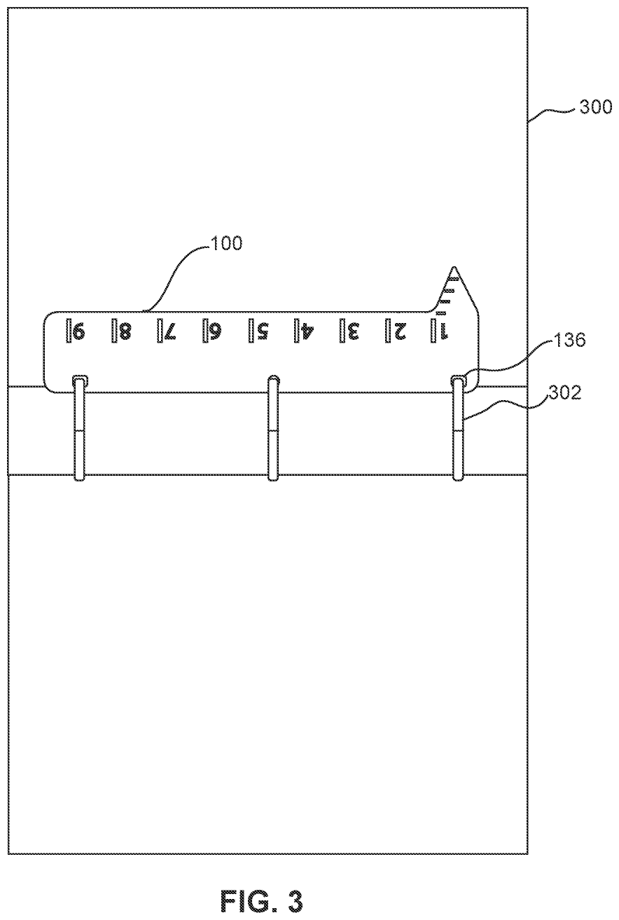

FIG. 3 illustrates a plan view of binder dibble 100 stowed in a three-ring binder 300, in accordance with at least one implementation. In at least one implementation, binder holes 136 are aligned with clamp rings 302 in three-ring binder 300. In at least one implementation, binder dibble 100 can be stowed in three-ring binder 300 by attaching clamp rings 302 through binder holes 136. In at least one implementation, the flat geometry of binder dibble 100 enables stowage within three-ring binder 300 within a minimal space. Multiple binder dibbles may be stowed in a single three-ring binder. While a three-ring binder 300 is shown in FIG. 3, binder dibble 100 may be configured to accommodate two-ring binders as well.

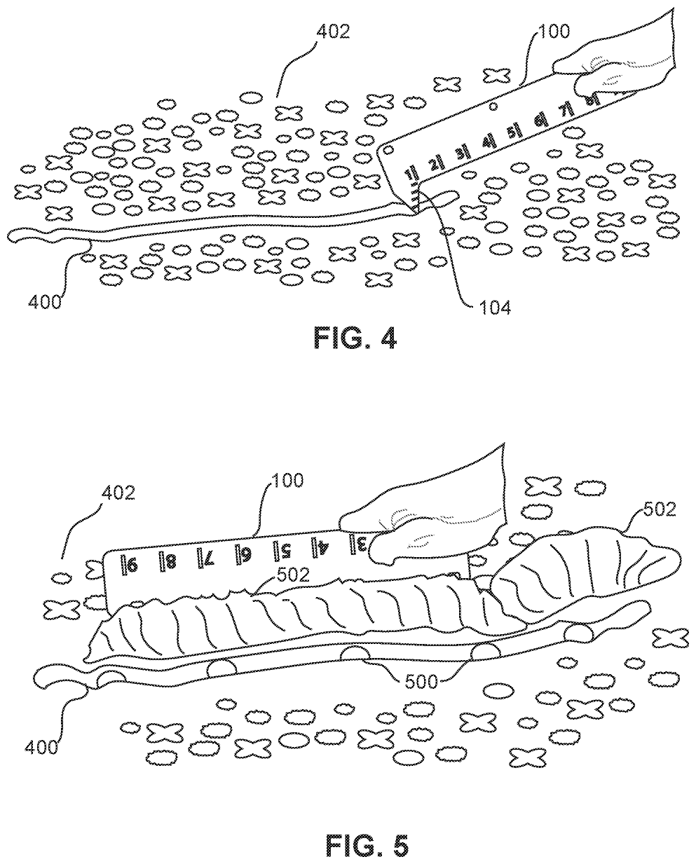

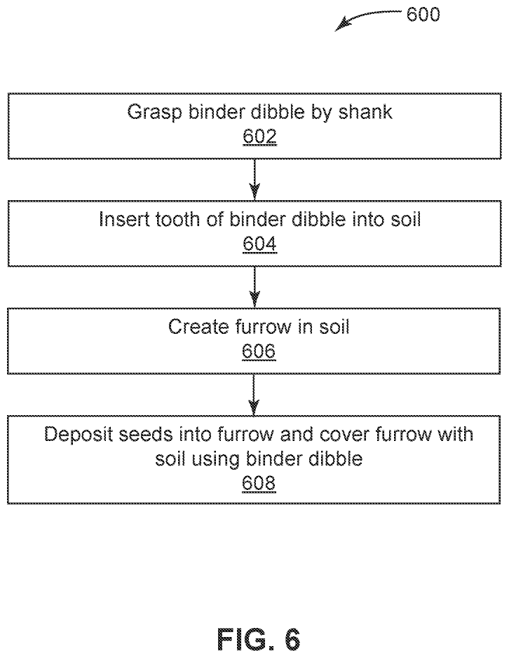

FIG. 4 illustrates a view of binder dibble 100 in use to prepare for planting, in accordance with one implementation. In the illustrated implementation, binder dibble 100 is employed to create a furrow 400 in soil 402. In at least one implementation, tooth 104 of binder dibble 100 is inserted into soil 402 and pulled through soil 402 toward the user to form furrow 400. Tooth 104 may be inserted into soil 402 by a smashing or pounding action, for example, then dragged through soil 402. In a similar manner, binder dibble 100 may form holes in soil 402 by poking tooth 104 into soil by a hammer action. Furrow creation using binder dibble 100 is explained in greater detail in reference to the method flowchart shown in FIG. 6.

FIG. 5 illustrates a view of binder dibble 100 in use to finish planting, in accordance with at least one implementation. In the illustrated implementation, binder dibble 100 is employed to cover a plurality of seeds 500 deposited in furrow 400. In at least one implementation, binder dibble 100 is employed to scrape loose soil 502 into furrow 400, covering deposited seeds 500. Details

FIG. 6 illustrates flowchart 600 summarizing a method of using binder dibble 100, in accordance with at least one implementation. Referring to FIG. 1A, at operation 602, binder dibble 100 is grasped by shank 102 with hand of user behind front edge 110. Tooth 104 protrudes below lower edge 108. In at least one implementation, binder dibble 100 is held in a manner similar to grasping a hammer.

At operation 604, tooth 104 of binder dibble 100 is inserted into garden soil (e.g., soil 402). Garden soil may be prepared to be worked by binder dibble 100 by prior digging, plowing, or turning. By such preparation, garden soil may be soft. Tooth 104 may be inserted into the soil by a striking the soil with binder dibble 100 as one would use a hammer, firmly grasping shank 102 and driving tooth 104 into the soil to create a smash point (e.g., break) in the soil. Low striking force, such as that exerted by an elementary school or middle school student, may be sufficient to insert tooth 104 into the garden soil. The depth of penetration into the soil may be guided by depth marks 134 on tooth 104. For example, depth marks 134 are spaced apart by increments of 0.25 inch. A depth of 0.5 inch may be achieved by sinking tooth 104 to the second depth mark on tooth 104.

At operation 606, tooth 104 may form a furrow (e.g., furrow 400) in the soil. In at least one implementation, a pulling action may be employed by the user to drag tooth 104 a distance through the soil, for example, in a line by pulling tooth 104 toward the user, to create a rough furrow. In at least one implementation, a long edge of shank 102, for example upper edge 106, may be used to smooth over the worked soil so it is level prior to making the furrow. At operation 608, seeds are deposited into the furrow. Rule marks along shank 102 may be used to gauge distance between seeds within a row containing the furrow. For example, shank 102 may be employed as a ruler, measuring distances of 3 inches using the rule marks to place seeds at regular 3-inch intervals in the furrow. For example, binder dibble 100 may be inverted to contact upper edge 106 to soil, where shank 102 may be employed to scrape a mass of loose soil (e.g., loose soil 502) into the furrow to cover newly deposited seeds and smooth the soil over the seeds. In at least one implementation, multiple furrows may be created in parallel by repeating the steps in operations 604 through 608. In at least one implementation, rule marks 130 on shank 102 may be used to gauge distance between furrows (e.g., rows). For example, furrows may be created in parallel rows at 12-inch intervals using shank 102 to measure 12 inches.

In the following paragraphs, examples are provided that illustrate various implementations. Here, examples can be combined with other examples. As such, various implementations can be combined with other implementations without changing scope of disclosure.

Example 1 is a garden dibble, comprising a shank, wherein the shank is rectilinear and has a rectangular footprint and a rectangular cross section, wherein the shank has a length, a width and a thickness, wherein the thickness is between a first face of the shank and a second face of the shank opposite the first face, wherein the length is at least 6 times the thickness and the width is at least twice the thickness a plurality of rule marks on the first face of the shank, wherein the plurality of rule marks is distributed along the length of the shank at least two holes extending through the thickness of the shank between the first face and the second face, wherein the at least two holes are distributed along the length of the shank; and a tooth that extends from an end of the shank, wherein the tooth is substantially triangular, wherein the tooth extends from a long edge of the shank and comprises an apex that is oriented orthogonally to a long axis of the shank, and wherein a plurality of depth marks is distributed on a third face of the tooth, and wherein the third face is substantially coplanar and contiguous with the first face.

Example 2 is an apparatus according to any example herein, in particular example 1, wherein the shank has a length to width aspect ratio that is between 6:1 and 30:1.

Example 3 is an apparatus according to any example herein, in particular example 1, wherein the shank has a width to thickness aspect ratio that is between 2:1 and 40:1.

Example 4 is an apparatus according to any example herein, in particular example 1, wherein the shank includes two opposing long edges and two opposing short edges, where the two opposing long edges extend along the length of the shank and the two opposing short edges extend along the width of the shank, wherein the two opposing long edges are joined to the two opposing short edges by a plurality of fillets, wherein individual fillets of the plurality of fillets extend between an individual long edge of the two opposing long edges and an individual short edge of the two opposing short edges, and wherein the individual fillets follow substantially circular arcs having a radius of curvature between 0.1 inch and 0.5 inch.

Example 5 is an apparatus according to any example herein, in particular example 4, wherein the tooth extends between one inch and two inches from a base of the tooth to the apex, and wherein the base is colinear with a first long edge of the two opposing long edges of the shank.

Example 6 is an apparatus according to any example herein, in particular example 5, wherein the base of the tooth extends between 0.5 inch and 3 inches.

Example 7 is an apparatus according to any example herein, in particular example 5, wherein the tooth comprises a leading edge and a trailing edge, and wherein the leading edge and the trailing edge extend at a first oblique angle and at a second oblique angle, respectively, from the base.

Example 8 is an apparatus according to any example herein, in particular example 7, wherein the leading edge extends at a right angle from the base.

Example 9 is an apparatus according to any example herein, in particular example 7, wherein the apex has an angle that is subtended by the leading edge and the trailing edge, and wherein the angle is between 30 degrees and 60 degrees.

Example 10 is an apparatus according to any example herein, in particular example 7, wherein the plurality of depth marks is distributed along the trailing edge of the tooth.

Example 11 is an apparatus according to any example herein, in particular example 5, wherein the plurality of depth marks is distributed between the base and the apex of the tooth, wherein individual depth marks of the plurality of depth marks are separated by an incremental distance ranging between 0.1 and 0.5 inch.

Example 12 is an apparatus according to any example herein, in particular example 1, wherein individual depth marks of the plurality of depth marks extend partially across the third face of the tooth.

Example 13 is an apparatus according to any example herein, in particular example 1, wherein the apex of the tooth has a radius of curvature between 0.1 inch and 0.5 inch.

Example 14 is a garden dibble, comprising a shank, wherein the shank comprises a front face and a rear face, wherein the front face and the rear face are rectangular, a first long edge and an opposing second long edge, a first short edge and an opposing second short edge, wherein the first short edge and the opposing second short edge extend orthogonally between the first long edge and the opposing second long edge, wherein the shank has a length, a width and a thickness, wherein the thickness extends between the front face and the rear face; a plurality of rule marks on the front face of the shank, wherein the plurality of rule marks is distributed along the length of the shank; at least two holes extending through the thickness of the shank between the front face and the rear face, wherein the at least two holes are distributed along the length of the shank; and a tooth that extends from an end of the shank and is contiguous with the shank, wherein the tooth is substantially triangular, wherein the tooth extends from the opposing second long edge of the shank and comprises an apex that is oriented orthogonally to the opposing second long edge of the shank, and wherein a plurality of depth marks is distributed on a marked face of the tooth, and wherein the marked face is substantially coplanar and contiguous with the front face.

Example 15 is an apparatus according to any example herein, in particular example 14, wherein the at least two holes comprise three holes distributed along the length of the shank, wherein the at least two holes are adjacent to the first long edge of the shank, and wherein the at least two holes are configured to align to at least two clamp rings of a ring binder.

Example 16 is an apparatus according to any example herein, in particular example 15, wherein the three holes comprise a first hole, a second hole and a third hole, wherein the first hole is located within a first end portion of the shank, wherein the third hole is located within a second end portion of the shank, wherein the first end portion is opposite the second end portion, wherein the second hole is located in a center portion of the shank, and wherein the first hole and the third hole are oval-shaped and the second hole is circular.

Example 17 is an apparatus according to any example herein, in particular example 14, wherein the first long edge is joined to the first short edge by a first fillet and is joined to the opposing second short edge by a second fillet, wherein the first fillet and the second fillet follow circular arcs having a radius of curvature between 0.1 inch and 0.5 inch.

Example 18 is an apparatus according to any example herein, in particular example 14, wherein the opposing second long edge is joined to the opposing second short edge by a third fillet, wherein the third fillet follows a circular arc having a radius of curvature between 0.1 and 0.5 inch, and wherein the opposing second long edge is joined to the tooth by a fourth fillet, wherein the fourth fillet follows a circular arc or oval arc having a radius of curvature between 0.1 inch and 0.5 inch.

Example 19 is an apparatus according to any example herein, in particular example 14, wherein individual rule marks of the plurality of rule marks are separated by an incremental distance of one inch.

Example 20 is an apparatus according to any example herein, in particular example 14, wherein individual depth marks of the plurality of depth marks are separated by an incremental distance of 0.25 inch to 0.5 inch.

Example 21 is an apparatus according to any example herein, in particular example 14, wherein the shank and the tooth have a polycarbonate composition.

Example 22 is a method for using a garden dibble, wherein the garden dibble comprises a shank, wherein the shank comprises a front face and a rear face, wherein the front face and the rear face are rectangular, a first long edge and an opposing second long edge, a first short edge and an opposing second short edge, wherein the first short edge and the opposing second short edge extend orthogonally between the first long edge and the opposing second long edge, wherein the shank has a length, a width and a thickness, wherein the thickness extends between the front face and the rear face; a plurality of rule marks on the front face of the shank, wherein the plurality of rule marks is distributed along the length of the shank; at least two holes extending through the thickness of the shank between the front face and the rear face, wherein the at least two holes are distributed along the length of the shank; and a tooth that extends from an end of the shank, wherein the tooth is substantially triangular, wherein the tooth extends from the opposing second long edge of the shank and comprises an apex that is oriented orthogonally to the opposing second long edge of the shank, and wherein a plurality of depth marks is distributed on a marked face of the tooth, and wherein the marked face is substantially coplanar and contiguous with the front face, wherein the method comprises smoothing a portion of worked garden soil with the shank of the garden dibble; inserting the tooth into the portion of the garden soil; forming a furrow in the portion of the garden soil with the tooth; planting seeds in the furrow; and covering the furrow with the shank with the shank of the garden dibble.

Example 23 is a method according to any example herein, in particular example 22, wherein smoothing the portion of the garden soil with the shank of the garden dibble includes scraping the portion of the garden soil with the first long edge of the shank.

Example 24 is a method according to any example herein, in particular example 22, wherein forming the furrow in the portion of the garden soil with the tooth includes dragging the tooth a distance through the portion of the garden soil.

Example 25 is a method according to any example herein, in particular example 22, wherein covering the furrow with the shank includes inverting the garden dibble and scraping a mass of loose soil into the furrow with the first long edge of the shank.

Example 26 is a method according to any example here, in particular example 22, wherein the furrow is a first furrow in a first row, and wherein forming a furrow within the portion of the garden soil further includes forming a second furrow in a second row a distance from the first furrow in the first row, wherein the distance is gauged by measuring the distance with at least some of the plurality of rule marks on the shank.

Besides what is described herein, various modifications can be made to disclosed implementations and implementations thereof without departing from their scope. Therefore, illustrations of implementations herein should be construed as examples, and not restrictive to scope of present disclosure.

We claim:

1. A garden dibble, comprising:
a shank, wherein the shank is rectilinear and has a rectangular footprint and a rectangular cross section, wherein the shank has a length, a width and a thickness, wherein the thickness is between a first face of the shank and a second face of the shank opposite the first face, wherein the length is at least 6 times the thickness and the width is at least twice the thickness;
a plurality of rule marks on the first face of the shank, wherein the plurality of rule marks is distributed along the length of the shank;
at least two holes extending through the thickness of the shank between the first face and the second face, wherein the at least two holes are distributed along the length of the shank; and
a tooth that extends from an end of the shank, wherein the tooth is substantially triangular, wherein the tooth extends from a long edge of the shank and comprises an apex that is oriented orthogonally to a long axis of the shank, and wherein a plurality of depth marks is distributed on a third face of the tooth, and wherein the third face is substantially coplanar and contiguous with the first face.

2. The garden dibble of claim 1, wherein the shank has a length to width aspect ratio that is between 6:1 and 30:1.

3. The garden dibble of claim 1, wherein the shank has a width to thickness aspect ratio that is between 2:1 and 40:1.

4. The garden dibble of claim 1, wherein the shank includes two opposing long edges and two opposing short edges, where the two opposing long edges extend along the length of the shank and the two opposing short edges extend along the width of the shank, wherein the two opposing long edges are joined to the two opposing short edges by a plurality of fillets, wherein individual fillets of the plurality of fillets extend between an individual long edge of the two opposing long edges and an individual short edge of the two opposing short edges, and wherein the individual fillets follow substantially circular arcs having a radius of curvature between 0.1 inch and 0.5 inch.

5. The garden dibble of claim 4, wherein the tooth extends between one inch and two inches from a base of the tooth to the apex, and wherein the base is colinear with a first long edge of the two opposing long edges of the shank.

6. The garden dibble of claim 5, wherein the base of the tooth extends between 0.5 inch and 3 inches.

7. The garden dibble of claim 5, wherein the tooth comprises a leading edge and a trailing edge, and wherein the leading edge and the trailing edge extend at a first oblique angle and at a second oblique angle, respectively, from the base.

8. The garden dibble of claim 7, wherein the leading edge extends at a right angle from the base.

9. The garden dibble of claim 7, wherein the apex has an angle that is subtended by the leading edge and the trailing edge, and wherein the angle is between 30 degrees and 60 degrees and wherein the apex of the tooth has a radius of curvature between 0.1 inch and 0.5 inch.

10. The garden dibble of claim 7, wherein:
the plurality of depth marks is distributed between the base and the apex of the tooth;
individual depth marks of the plurality of depth marks are separated by an incremental distance ranging between 0.1 and 0.5 inch;
individual depth marks of the plurality of depth marks extend partially across the third face of the tooth; and
the plurality of depth marks is distributed along the trailing edge of the tooth.

11. A garden dibble, comprising:
a shank, wherein the shank comprises a front face and a rear face, wherein the front face and the rear face are rectangular, a first long edge and an opposing second long edge, a first short edge and an opposing second short edge, wherein the first short edge and the opposing second short edge extend orthogonally between the first long edge and the opposing second long edge, wherein the shank has a length, a width and a thickness, wherein the thickness extends between the front face and the rear face;
a plurality of rule marks on the front face of the shank, wherein the plurality of rule marks is distributed along the length of the shank;
at least two holes extending through the thickness of the shank between the front face and the rear face, wherein the at least two holes are distributed along the length of the shank; and
a tooth that extends from an end of the shank and is contiguous with the shank, wherein the tooth is substantially triangular, wherein the tooth extends from the opposing second long edge of the shank and comprises an apex that is oriented orthogonally to the opposing second long edge of the shank, and wherein a plurality of depth marks is distributed on a marked face of the tooth, and wherein the marked face is substantially coplanar and contiguous with the front face.

12. The garden dibble of claim 11, wherein the at least two holes comprise three holes comprising a first hole, a second hole and a third hole distributed along the length of the shank, wherein the first hole is located within a first end portion of the shank, wherein the third hole is located within a second end portion of the shank, wherein the first end portion is opposite the second end portion, wherein the second hole is located in a center portion of the shank wherein the first hole and the third hole are oval-shaped and the second hole is circular, and wherein the at least two holes are configured to align to at least two clamp rings of a ring binder.

13. The garden dibble of claim 11, wherein:
the first long edge is joined to the first short edge by a first fillet and is joined to the opposing second short edge by a second fillet, wherein the first fillet and the second fillet follow circular arcs having a radius of curvature between 0.1 inch and 0.5 inch;
the opposing second long edge is joined to the opposing second short edge by a third fillet, wherein the third fillet follows a circular arc having a radius of curvature between 0.1 and 0.5 inch; and
the opposing second long edge is joined to the tooth by a fourth fillet, wherein the fourth fillet follows a circular arc or oval arc having a radius of curvature between 0.1 inch and 0.5 inch.

14. The garden dibble of claim 11, wherein individual rule marks of the plurality of rule marks are separated by an incremental distance of one inch, and wherein individual depth marks of the plurality of depth marks are separated by an incremental distance of 0.25 inch to 0.5 inch.

15. The garden dibble of claim 11, wherein the shank and the tooth have a polycarbonate composition.

16. A method for using a garden dibble, wherein the garden dibble comprises:
a shank, wherein the shank comprises a front face and a rear face, wherein the front face and the rear face are rectangular, a first long edge and an opposing second long edge, a first short edge and an opposing second short edge, wherein the first short edge and the opposing second short edge extend orthogonally between the first long edge and the opposing second long edge, wherein the shank has a length, a width and a thickness, wherein the thickness extends between the front face and the rear face;
a plurality of rule marks on the front face of the shank, wherein the plurality of rule marks is distributed along the length of the shank;
at least two holes extending through the thickness of the shank between the front face and the rear face, wherein the at least two holes are distributed along the length of the shank; and
a tooth that extends from an end of the shank, wherein the tooth is substantially triangular, wherein the tooth extends from the opposing second long edge of the shank and comprises an apex that is oriented orthogonally to the opposing second long edge of the shank, and wherein a plurality of depth marks is distributed on a marked face of the tooth, and wherein the marked face is substantially coplanar and contiguous with the front face,
wherein the method comprises:
smoothing a portion of a garden soil with the shank of the garden dibble;
inserting the tooth into the portion of the garden soil;
forming a furrow in the portion of the garden soil with the tooth;
planting seeds in the furrow; and
covering the furrow with the shank with the shank of the garden dibble.

17. The method of claim 16, wherein smoothing the portion of the garden soil with the shank of the garden dibble includes scraping the portion of the garden soil with the first long edge of the shank.

18. The method of claim 16, wherein forming the furrow in the portion of the garden soil with the tooth includes dragging the tooth a distance through the portion of the garden soil.

19. The method of claim 16, wherein covering the furrow with the shank includes scraping a mass of loose soil into the furrow with the first long edge of the shank.

20. The method of claim 16, wherein the furrow is a first furrow in a first row, and wherein forming the furrow within the portion of the garden soil further includes forming a second furrow in a second row a distance from the first furrow in the first row, wherein the distance is gauged by measuring the distance with at least some of the plurality of rule marks on the shank.
